(19) United States
(12) Patent Application Publication
(10) Pub. No.: US 2026/0008363 A1
(43) Pub. Date: Jan. 8, 2026

(54) Electric Vehicle Charger Emergency Release

(71) Applicant: GM GLOBAL TECHNOLOGY OPERATIONS LLC, Detroit, MI (US)

(72) Inventors: Omar SANCHEZ DE LA TORRE, Farmington Hills, MI (US); Joseph Bednarek, Farmington Hills, MI (US); Alexander Milne Allan, Howell, MI (US); James C. Gibbs, Brighton, MI (US)

(21) Appl. No.: 18/761,888

(22) Filed: Jul. 2, 2024

(51) Int. Cl. B60L 53/16; B60L 53/53; B60L 58/10

(52) U.S. Cl. CPC B60L 53/16; B60L 53/53; B60L 58/10

(57) ABSTRACT

A vehicle system includes a charging port and a control module. The charging port is configured to attach to a charger plug via a latching member. The charging port includes an ejector, an actuator coupled to the ejector, and a release device. The control module is configured to receive an input signal to release the charger plug from the charging port while the charger plug is providing power to the electric vehicle, in response to receiving the input signal, control the release device to release the latching member of the charger plug from the charging port, control the actuator to cause the ejector to extend from the charging port to eject the charger plug, and in response to the charger plug being ejected, enable a propulsion system of the electric vehicle. Other example vehicle system and control methods are also disclosed.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to vehicle systems and control methods for automatically releasing charger plugs from charging ports in electric vehicles.

Electric vehicles, such as battery electric vehicles, hybrid vehicles, and/or fuel cell vehicles, include one or more electric machines and a battery system. For example, a battery system in an electric vehicle may be a rechargeable energy storage system including one or more high voltage battery packs each having a collection of battery cells. To charge the battery system, a charger plug is electrically coupled to a charging port of the electric vehicle via one or more connectors and physically attached to the charging port via a latch. During this charging time, a propulsion system of the electric vehicle is disabled.

### SUMMARY

A vehicle system for automatically releasing a charger plug having a latching member from an electric vehicle, includes a charging port and a control module. The charging port is configured to attach to the charger plug via the latching member. The charging port includes at least one ejector, an actuator coupled to the at least one ejector, and a release device. The control module is configured to receive an input signal to release the charger plug from the charging port while the charger plug is providing power to the electric vehicle, in response to receiving the input signal, control the release device to release the latching member of the charger plug from the charging port, control the actuator to cause the at least one ejector to extend from the charging port to eject the charger plug, and in response to the charger plug being ejected, enable a propulsion system of the electric vehicle.

In other features, the control module is configured to transmit a control signal to a charger control module in the charger plug to command a charging current to zero in response to receiving the input signal.

In other features, the vehicle system further includes a switching device coupled between an input of the charging port and a battery module in the electric vehicle for providing power to the battery module from the charger plug when the charger plug is attached to the charging port.

In other features, the control module is configured to sense the charging current and control the switching device to open in response to charging current being below a threshold to remove a charging voltage.

In other features, the control module is configured to in response to receiving the input signal, determine whether the latching member of the charger plug is released from the charging port, and in response to the latching member not being released, enable the propulsion system of the electric vehicle.

In other features, the control module is configured to determine whether a vehicle door is open and in response to determining that the vehicle door is open, automatically control the vehicle door to close.

In other features, the control module is configured to determine whether a vehicle window is down, and in response to determining that the vehicle window is down, automatically control the vehicle window to close.

In other features, the control module is configured to determine whether a vehicle door is locked and in response to determining that the vehicle door is unlocked, automatically control the vehicle door to lock.

In other features, the control module is configured to activate an output device in response to receiving the input signal.

In other features, the output device includes at least one of an audible alarm or a visual alarm.

In other features, the control module is configured to activate a recording device in response to receiving the input signal.

In other features, the control module is configured to initiate communication with an emergency service provider in response to receiving the input signal.

In other features, the release device includes a solenoid and the ejector includes one or more movable pins.

In other features, the input signal is a user generated signal or a signal generated without user interaction.

A control method for automatically releasing a charger plug having a latching member from a charging port of an electric vehicle is disclosed. The charging port includes at least one ejector, an actuator coupled to the at least one ejector, and a release device. The control method includes receiving an input signal to release the charger plug from the charging port of the electric vehicle while the charger plug is providing power to the electric vehicle, in response to receiving the input signal, controlling the release device of the charging port to release the latching member of the charger plug from the charging port, controlling the actuator of the charging port to cause the at least one ejector of the charging port to extend from the charging port to eject the charger plug, and in response to the charger plug being ejected, enabling a propulsion system of the electric vehicle.

In other features, the control method further includes transmitting a control signal to a charger control module in the charger plug to command a charging current to zero in response to receiving the input signal.

In other features, the control method further includes sensing the charging current and in response to charging current being below a threshold, controlling a switching device coupled between an input of the charging port and a battery module in the electric vehicle to open.

In other features, the control method further includes activating at least one of an audible alarm or a visual alarm in response to receiving the input signal.

In other features, the control method further includes initiating communication with an emergency service provider in response to receiving the input signal.

In other features, the release device includes a solenoid and the ejector includes one or more movable pins.

A vehicle system for automatically releasing a charger plug from an electric vehicle, includes a charging port, a switching device, and a control module. The charging port is configured to attach to the charger plug. The charging port includes at least one ejector and an actuator coupled to the at least one ejector. The switching device is coupled between an input of the charging port and a battery module in the electric vehicle for providing power to the battery module from the charger plug when the charger plug is attached to the charging port. The control module is configured to receive an input signal to release the charger plug from the charging port while the charger plug is providing power to the electric vehicle, in response to receiving the input signal, transmit a control signal to a charger control module in the charger plug to command a charging current to zero, control the switching device to open, and in response to opening the switching device, control the actuator to cause the at least one ejector to extend from the charging port to eject the charger plug.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a block diagram of an example vehicle system for automatically releasing a charger plug from an electrical vehicle, according to the present disclosure;

FIG. 2 is an electrical vehicle including portions of the vehicle system of FIG. 1, according to the present disclosure;

FIG. 3 is a block diagram of an example charging port, according to the present disclosure;

FIG. 4 is a block diagram of an example charger plug, according to the present disclosure;

FIG. 5 is a block diagram of an example charging system, according to the present disclosure; and

FIGS. 6-8 are flowcharts of example control processes for automatically releasing a charger plug from an electrical vehicle, according to the present disclosure.

In the drawings, reference numbers may be reused to identify similar and/or identical elements.

### DETAILED DESCRIPTION

A vehicle, such as an electrical vehicle (EV) often relies on a rechargeable energy storage system (RESS) for storing and supplying power to propel the vehicle. In such examples, the RESS includes one or more high voltage battery packs each having a collection of battery cells. To charge the RESS, a charger plug at a charging station is inserted into a charging port of the electric vehicle, thereby electrically coupling the charger plug and the charging port via one or more connectors and physically attaching (e.g., physical latching, etc.) the charger plug and the charging port via a latch. During this charging time, the vehicle is immobilized due to its propulsion system being disabled while the vehicle is physically connected to the charger plug. In other words, the vehicle control system will not allow the powertrain to go into propulsion while the charger plug is detected. This presents major safety concerns during charging as some charging stations include unsafe or potentially unsafe conditions. For example, some charging stations may be found in parking lots with limited or poor visibility, particularly at night and/or may be in high-risk locations, such as areas with threatening conditions (e.g., weather conditions, environmental surroundings, potential criminal attacks, etc.). For instance, some vehicles, such as autonomous vehicles may provide alerts and move based on weather conditions, such as detected tornados in the area. Additionally, in some examples, the unsafe or potentially unsafe conditions may relate to vehicle conditions, such as a detected thermal runaway in a vehicle battery cell, etc.

The vehicle systems and methods according to the present disclosure enable the automatic emergency release and disconnection of a charging port of an EV from a connected charger plug, thereby allowing a vehicle to move (e.g., autonomously move, etc.) and/or a driver to safely drive away without forcing the driver to exit the vehicle to manually unplug the charger plug. For example, and as further explained herein, the automatic emergency release may be initiated through the activation of a user input located inside the vehicle and/or automatically initiated without user interaction. With this approach, the vehicle systems and methods can safely and quickly disable charging, eject a charger plug, and enable a propulsion system as part of an overall emergency response that allows an immobilized vehicle to escape a dangerous situation. As such, the charger plug can be quickly detached and ejected, thereby allowing the vehicle to move (e.g., autonomously move, etc.) and/or the driver to drive away from a potential hazardous situation without the need to exit the vehicle. For example, the driver may be able to drive away from a potential hazardous situation within about 1.5 to 2 seconds of initiating the automatic emergency release. Additionally, in some examples, the vehicle systems and methods may allow for the enablement of a propulsion system in the vehicle while the charger plug is still connected to the charging port.

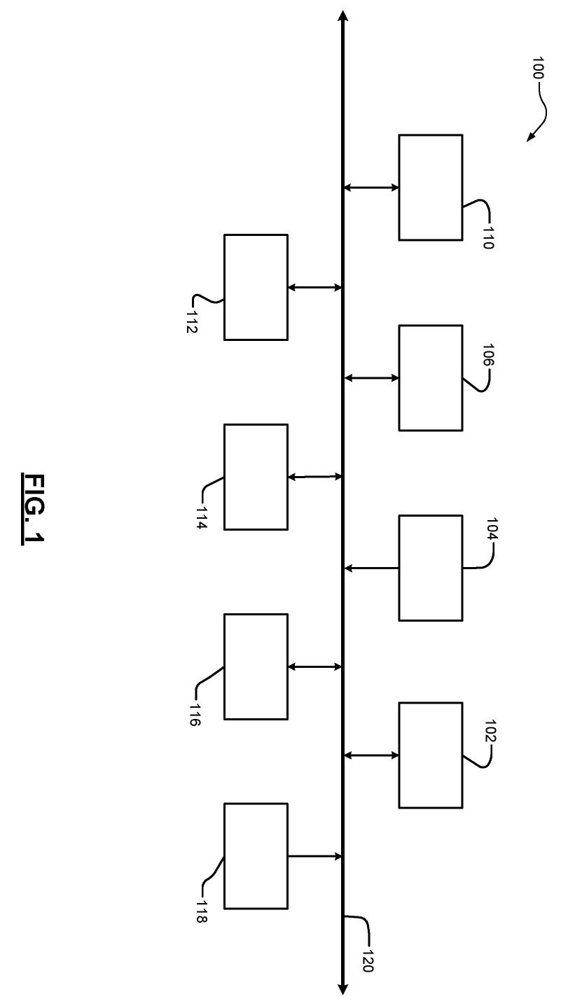

Referring now to FIG. 1, a block diagram of an example vehicle system 100 is presented for automatically releasing a charger plug from an EV. As shown in FIG. 1, the vehicle system 100 generally includes a control module 102, a user input 104, a propulsion control module 106, an emergency control module 110, a recording device 112, an actuator 114, a release device 116, and one or more sensors (collectively referred to as sensors 118) for detecting or sensing vehicle characteristics. For example, the sensors 118 may include a charging current sensor, a vehicle window sensor, a vehicle door sensor, a vehicle trunk sensor, a vehicle lock sensor, etc.

Although FIG. 1 illustrates the vehicle system 100 as including specific modules, it should be appreciated that one or more other modules may be employed if desired. Additionally, while the vehicle system 100 is shown as including multiple separate modules, any combination of the modules (e.g., the control module 102, the propulsion control module 106, the emergency control module 110, etc.) and/or the functionality thereof may be integrated into one or more modules.

In various embodiments, the modules, devices, and sensors of the vehicle system 100 may be in communication with each other and may share parameters via a network 120, such as a controller area network (CAN), ethernet, and/or any other suitable method of inter-vehicle communication. In such examples, the parameters may be shared via one or more data buses of the network 120. As such, various parameters may be made available by a given module and/or sensor to other modules, devices and/or sensors via the network 120.

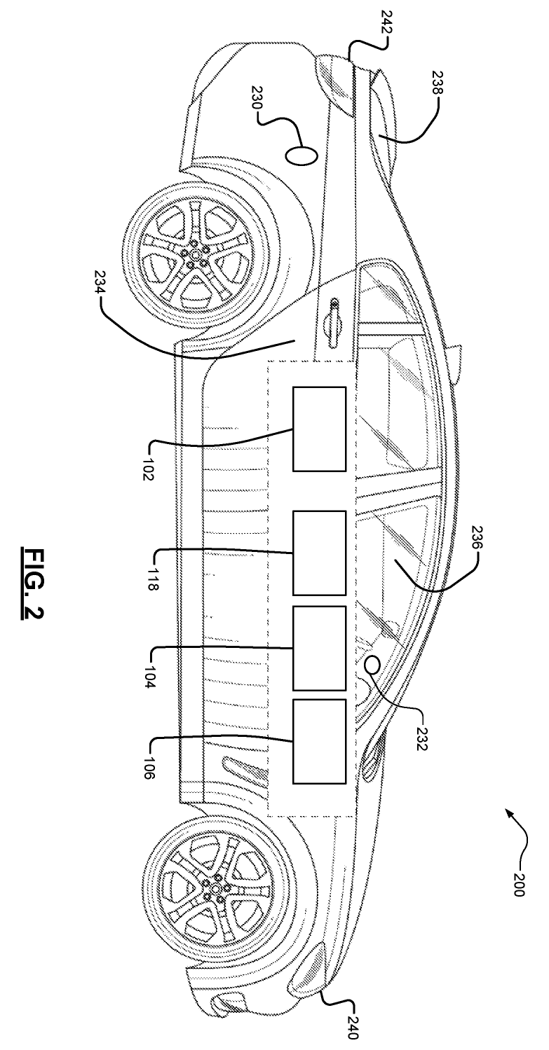

The vehicle system 100 of FIG. 1 may be employable in any suitable vehicle, such as an electric vehicle (e.g., a pure electric vehicle, a plug-in hybrid electric vehicle, etc.), etc. Additionally, the vehicle system 100 may be applicable to an autonomous vehicle, a semi-autonomous vehicle, etc. For example, FIG. 2 depicts an EV 200 including the control module 102, the user input 104, the propulsion control module 106, and the sensors 118 of FIG. 1.

Additionally, and as shown in FIG. 2, the EV 200 includes a charging port 230 positioned on a body of the EV 200 for use in charging a battery system (e.g., a RESS). For example, the charging port 230 may receive and attach to a charger plug for providing power to the EV 200, and more specifically to the battery system. In such examples, the charger plug may be electrically coupled to the charging port 230 via one or more connectors. In some examples, the charger plug may also be physically and/or magnetically attached to the charging port 230 via a latching member.

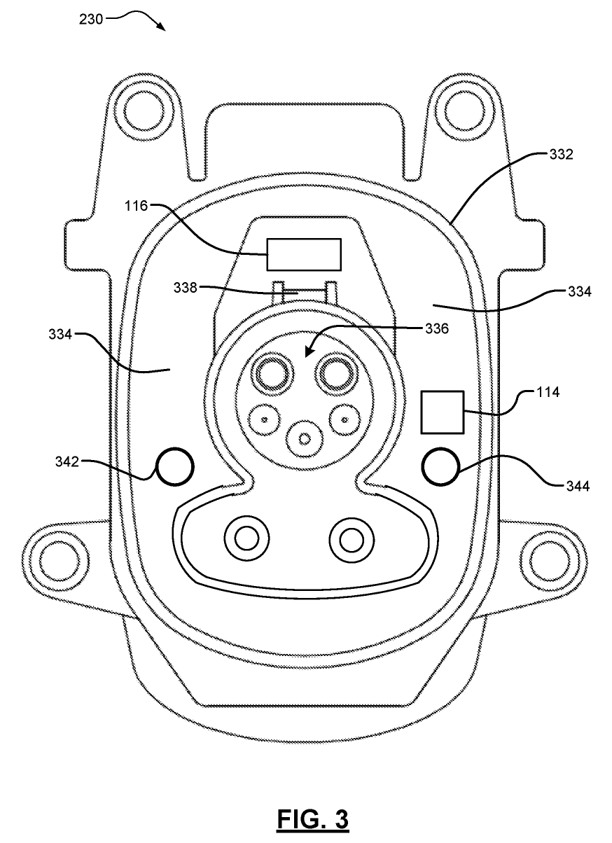

In various embodiments, the charging port 230 generally includes one or ejectors, an actuator coupled to the ejector(s), and a release device. For example, FIG. 3 depicts one example embodiment of the charging port 230 that may be employed with the EV 200 in FIG. 2. As shown in FIG. 3, the charging port 230 generally includes a body 332, a base plate 334, one or more connectors 336 (e.g., pins, contacts, etc.) positioned in the body 332 for electrically coupling with connectors of a corresponding charger plug, a latch receiver 338 for detachably coupling with a latching member of the corresponding charger plug, the release device 116 of FIG. 1 positioned adjacent to the latch receiver 338, and ejectors 342, 344. In the example of FIG. 3, the latch receiver 338 generally couples with the latching member (e.g., a movable member) via a mechanical latch engagement. In other examples, the charging port 230 may include another suitable latch receiver, such as a latch receiver that magnetically engages with the latching member of the charger plug.

In the example of FIG. 3, the release device 116 is a solenoid. For example, and as further explained herein, the solenoid may be controlled to move and press against a portion of the latching member of the charger plug. This movement and subsequent force against the latching member may release the latching member from the latch receiver 338 (e.g., overcome a biasing force of the latching member, overcome a magnetic force between the latching member and the latch receiver, etc.). In other examples, the release device 116 may include another suitable device to release the latching member from the latch receiver 338, such as a spring, an actuator, or another similar electric and/or mechanical component that would provide a pulse with enough magnitude to release the latching member.

Additionally, in the example of FIG. 3, the ejectors 342, 344 are two movable pins coupled to and controlled by the actuator 114 of FIG. 1. For example, the pins may be generally inset into the body 332 of the charging port 230 and positioned flush with the base plate 334. When desired, the pins may be controlled by the actuator 114 to move outwards and extend from the charging port 230, and more specifically the base plate 334. With the extension of the pins, the pins can apply a force against the charger plug. In doing so, the pins can eject or otherwise push the charger plug away from the charging port 230. In other examples, the ejectors 342, 344 may include more or less pins and/or another suitable device to eject or otherwise push the charger plug away from the charging port 230, such as a spring, a solenoid, or another similar electric and/or mechanical component that would provide a pulse with enough magnitude to eject the charger plug.

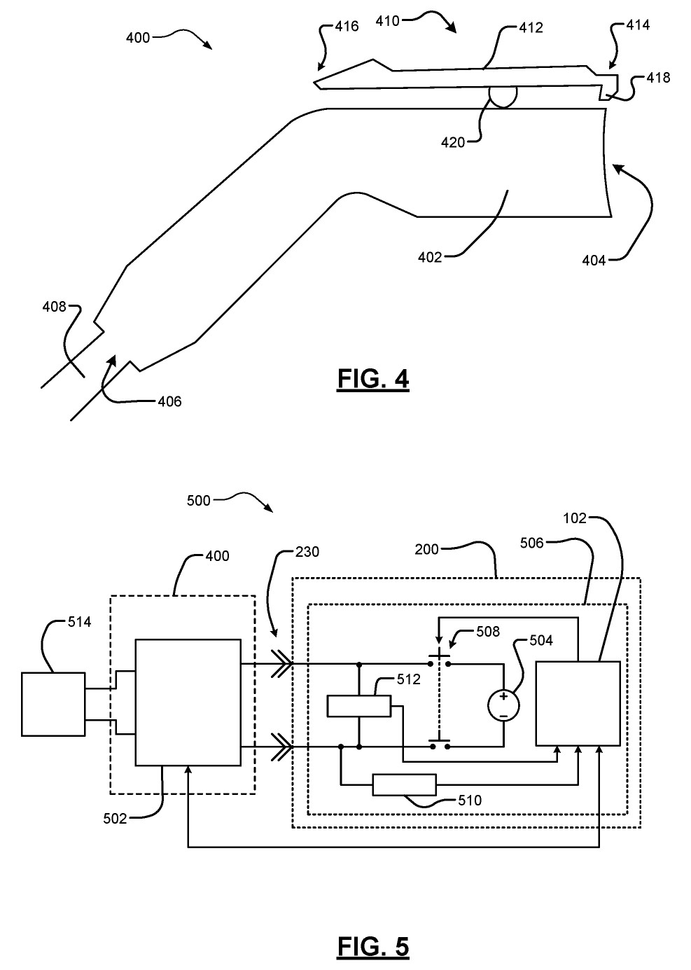

FIG. 4 depicts one example embodiment of a charger plug 400 that may be plugged into the charging port 230 of FIGS. 2-3 and/or another suitable charging port. In the example of FIG. 4, the charger plug 400 generally includes a body 402 having opposing ends 404, 406, an electrically conductive power cable 408, and a latching member 410. In this example, the end 404 of the charger plug 400 is positioned in a charging port, such as the charging port 230 of FIGS. 2-3 for providing power from a DC power source connected to the end 406 (via the power cable 408). While not shown, the charger plug 400 includes one or more connectors (e.g., pins, contacts, etc.) that may generally align with and connect with some or all of the connectors 336 of the charging port 230 in FIG. 3.

The latching member 410 may be employed to detachably couple to a charging port, such as the charging port 230 of FIGS. 2-3. For example, and as shown in FIG. 4, the latching member 410 includes a body 412 having opposing ends 414, 416, a latch (e.g., a clip) 418 at the end 414, and a biasing member 420. In this example, the biasing member 420 may include one or more springs or the like to apply a biasing force on the latch 418 at the end 414. In doing so, the biasing member 420 may force the latch 418 downwards towards the body 402 of the charger plug 400. When the charger plug 400 is plugged into the charging port 230, the latch 418 may be biased into and/or against the latch receiver 338 of the charging port 230 to attach the charger plug 400 and the charging port 230 together. Then, if desired, the release device 116 of the charging port 230 may be controlled to release the latch 418 from the latch receiver 338 as explained herein.

Although the charger plug 400 of FIG. 4 is shown and described as including the latching member 410 that couples with the latch receiver 338 in the charging port 230 of FIG. 3 via a mechanical latch engagement, it should be appreciated that the charger plug 400 of FIG. 4 and/or another charger plug may engage with the charging port 230 of FIG. 3 and/or another charging port in another suitable manner. For example, in some embodiments, the charger plug may include a latching member that magnetically engages with a latch receiver of a charger plug.

With continued reference to FIG. 1, the vehicle system 100 may be employed to automatically release (e.g., an emergency release) the charger plug 400 of FIG. 4 from the charging port 230 of the EV 200 of FIG. 2. In such examples, the charger plug 400 is electrically coupled to the charging port 230 via the one or more connectors for providing power to the EV 200, and physically attached to the charging port 230 (e.g., the latch receiver 338) via the latching member 410 (e.g., the latch 418). During this charging time, a propulsion system of the EV 200 is disabled. Although the example vehicle system 100 is described in relation to the EV 200, the charging port 230, and the charger plug 400 of FIGS. 2-4, it should be appreciated that the vehicle system 100 may be employable by other suitable EVs, charging ports, and/or charger plugs.

In the vehicle system 100 of FIG. 1, the EV charger emergency release may be initiated through the activation of a user input. For example, a user (e.g., a driver, a passenger, etc.) may select a user input 232 located inside a cabin of the EV 200 of FIG. 2. In such examples, the user input 232 may be a switch, a button, a lever, etc. located within reach of the driver. For instance, the user input 232 may be located on a dash of the EV 200, on a user interface near a center console of the EV 200, etc. Once selected, the control module 102 of FIG. 1 receives an input signal from the user input 232 to release the charger plug 400 from the charging port 230.

In other examples, the EV charger emergency release may be initiated via another suitable signal. For example, the control module 102 of FIG. 1 may receive an input signal indicating an unsafe or potentially unsafe condition, such as a dangerous weather condition (e.g., a tornado in the area), a potential criminal attack, an unsafe vehicle condition (e.g., a thermal runaway, etc.), etc. In such examples, the input signal may be generated and received by the control module 102 without user interaction. For example, the control module 102 may receive the input signal from external sources (e.g., an external weather system, etc.), internal sources (e.g., vehicle sensors, such as cameras, etc.), etc.

Then, the control module 102 controls the release device 116 in response to receiving the input signal (e.g., a user generated signal, a signal generated without user interaction, etc.). For example, the control module 102 may send a control signal to the release device 116 (e.g., a solenoid), thereby causing the release device 116 to move and press against a portion of the latching member 410. This in turn causes the latching member 410 along with the latch 418 to move away from the latch receiver 338 of the charging port 230. Once the latching member 410 has moved an appropriate distance, the latch 418 may be released or disengaged from the latch receiver 338.

In some examples, the control module 102 may cause the release device 116 to continuously press against the latching member 410 to maintain the latching member 410 in a released/disengaged state. For example, the control module 102 may activate the release device 116 and ensure the release device 116 remains active for a defined period of time. In various embodiments, the defined period of time may be calibratable to ensure sufficient time to allow the charger plug 400 to be ejected from the charging port 230 as explained herein.

Next, the control module 102 controls the actuator 114 to cause the ejectors 342, 344 to extend from the charging port 230 to eject the charger plug 400. For example, the control module 102 may activate the actuator 114 (via a transmitted control signal), thereby causing the ejectors 342, 344 (e.g., movable pins) to move outwards and extend from the charging port 230. In doing so, the ejectors 342, 344 may press against the charger plug 400 causing the charger plug 400 to move away from the charging port 230.

In various embodiments, the control module 102 may control the actuator 114 only after determining that the release device 116 has released or disengaged the latch 418 from the latch receiver 338. For example, the control module 102 may make this determination based on a sensor input (e.g., from one of the sensors 118) indicating a position/state of the release device 116, a position or absence of the latch 418, etc. In other examples, the control module 102 may activate the actuator 114 for a defined period of time after the release device 116 was activated to ensure the latch 418 is fully released/disengaged from the charging port 230.

Then, the control module 102 may enable a propulsion system of the EV 200. For example, in response to the charger plug 400 being ejected from the charging port 230, the control module 102 may send a control signal to the propulsion control module 106. In turn, the propulsion control module 106 may enable a powertrain of the EV 200 to go into propulsion, thereby allowing the driver to safely and quickly drive away without forcing the driver to exit the EV 200 to manually unplug the charger plug 400.

In other examples, the vehicle system 100 may allow the driver to drive away by optionally allowing propulsion enablement without the charger plug 400 being ejected. For example, in some scenarios, the ejection of the charger plug 400 may fail due to hardware failures, software failures, weather conditions (e.g., ice buildup, etc.), etc. In such examples, the vehicle system 100 can enable the propulsion system of the EV 200.

For instance, in various embodiments, the control module 102 may determine whether the latching member 410 is released from the charging port 230 based on a sensor input as explained above. In response to the latching member 410 not being released, the control module 102 may enable the propulsion system of the EV 200. In doing so, the powertrain of the EV 200 is allowed to go into propulsion to enable the driver to drive away with the charger plug 400 plugged into the charging port 230. At some point, the charger plug 400 may be pulled out of the charging port 230 due to the EV 200 moving away from a charging station with the charger plug 400. In some scenarios, this may cause damage to the charging port 230 and/or the charger plug 400.

In other embodiments, the charging port 230 and/or the charger plug 400 may be designed to separate upon drive-away. For example, the charging port 230 and/or the charger plug 400 may include a non-latching coupling design, a breakaway coupling design, and/or another design to allow the EV 200 and the charger plug 400 to separate upon drive-away without causing damage to the charging port 230 and/or the charger plug 400. In other examples, damage may be contained to a certain component (e.g., a designed failure) of the charging port 230 and/or the charger plug 400.

In some embodiments, the control module 102 may enable the propulsion system of the EV 200 while the charger plug 400 is plugged into the charging port 230 only if an appropriate input signal is received. For example, the control module 102 may only enable the propulsion system while actively charging if an override signal is received. In such examples, a user interface in the EV 200 may display a selectable input, which when selected may provide the override signal to the control module 102. This selectable input may be displayed, for example, after a failed attempt to eject the charger plug 400, if no ejectors are present, after a failed attempt to disengage the latching member 410, etc.

In various embodiments, the vehicle system 100 may optionally control power components in the charger plug 400 and/or the EV 200 to disable charging. For example, after receiving the input signal to activate the EV charger emergency release, the control module 102 may transmit a control signal to a charger control module in the charger plug 400 to command a charging current to zero and transmit a control signal to depower and remove a charging voltage between the charger plug 400 and the EV 200. In some examples, the control module 102 may transmit the control signal to the charger control module via a communication interface between the charging port 230 and the charger plug 400.

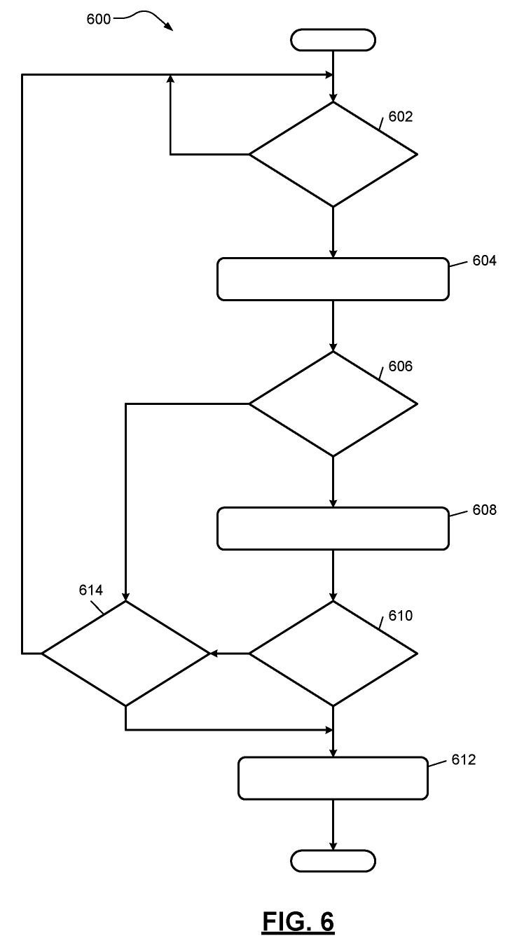

For example, FIG. 5 depicts an example charging system 500 including the EV 200 of FIG. 2 and the charger plug 400 of FIG. 4. As shown, the charger plug 400 is plugged into the charging port 230. In this example, the charger plug 400 (or a connected charging station) includes a charger-side control module 502 to control the supply of charging current from a DC source 514 to a battery module 504 in the EV 200. As shown, the EV 200 includes the control module 102 of FIG. 1 and a battery system 506 having the battery module 504 and a switching device 508 (e.g., contactors) connecting conductors to terminals of the battery module 504. In such examples, the control module 102 may transmit a control signal to the charger-side control module 502 to command a charging current to zero.

Additionally, in some examples, the control module 102 may control the switching device 508 or another suitable contact between the charger plug 400 and the battery module 504 to depower and remove a charging voltage between the charger plug 400 and the EV 200. For example, and as shown in FIG. 5, the switching device 508 is coupled between an input of the charging port 230 and the battery module 504 in the EV 200 for providing power to the battery module 504 from the charger plug 400. In such examples, the control module 102 may transmit a control signal to the switching device 508 to selectively open the switching device 508. Then, once open, the conductors (e.g., battery cables) may be depowered such that a voltage of the conductors will be zero. In various embodiments, the control module 102 may sense a voltage of the conductors with a voltage sensor 512.

In various embodiments, the control module 102 may transmit the control signal to open the switching device 508 only if certain conditions apply. For instance, the control module 102 may sense a charging current from the charger plug 400 with a current sensor 510 and then control the switching device 508 (via the control signal) to open in response to charging current being below a threshold. In such examples, the threshold may be zero, substantially zero, etc.

In some examples, the control module 102 may only control the release device 116 and the actuator 114 if the charging current is below the threshold and the switching device 508 is open. In other words, the control module 102 may only attempt to release the latch 418 through control of the release device 116 and then attempt to eject the charger plug 400 through control of the actuator 114 if power is disconnected.

Further, in various embodiments, the control module 102 may initiate one or more emergency steps in response to receiving the input signal to activate the EV charger emergency release. For example, the control module 102 may take preventive measures to ensure components of the EV 200 are in safe conditions. For instance, in some examples the control module 102 may determine whether any vehicle door of the EV 200 (e.g., a rear vehicle door 234, a front vehicle door, etc.) is open. The control module 102 may make this determination based on a sensor input (e.g., from one of the sensors 118) indicating a position/presence of each door. Then, in response to determining that a vehicle door is open, the control module 102 may automatically control that vehicle door to close via one or more actuators or the like. Additionally, the control module 102 may determine whether the vehicle doors are locked via a sensor input, and then, in response to determining that the vehicle door is unlocked, automatically control the vehicle doors to lock.

Likewise, the control module 102 may determine whether any vehicle window of the EV 200 (e.g., a rear vehicle window, a front vehicle window 236, a moonroof, etc.) is open. The control module 102 may make this determination based on a sensor input (e.g., from one of the sensors 118) indicating a position/presence of each window. Then, in response to determining that a vehicle window is open, the control module 102 may automatically control that vehicle window to close via one or more actuators or the like.

Further, the control module 102 may determine whether a vehicle trunk 238 of the EV 200 is open. The control module 102 may make this determination based on a sensor input (e.g., from one of the sensors 118) indicating a position/presence of each window. Then, in response to determining that a vehicle window is open, the control module 102 may automatically control that vehicle window to close via one or more actuators or the like.

Additionally, in some examples, the emergency steps may include the activation of one or more output devices to function as alarms. For example, the control module 102 may transmit control signals to activate a visual alarm and/or an audible alarm. In such examples, the visual alarm may include the flashing of head lights 240 and/or taillights 242 of the EV 200. Additionally, in some examples, the audible alarm may include speakers, a horn, etc. in the EV 200. In various embodiments, the speakers may output a repeating message, such as “In Danger, Please Help, Please Call 911.”

In other examples, the emergency steps may include the activation of the recording device 112. For example, the control module 102 may transmit control signals to activate the recording device 112, such as one or more cameras, microphones, etc. within or on the body of the EV 200 to capture video and/or audio near the EV 200. In some examples, the captured video and/or audio may be stored locally and/or transmitted (e.g., in real time) to another module (e.g., cloud-based storage, etc.).

Further, the emergency steps may include communicating with an emergency service provider. For instance, the control module 102 may transmit a control signal to the emergency control module 110 to initiate communication with OnStar or another example emergency service provider. In such examples, emergency services (e.g., police, EMT, etc.) maybe notified and respond if necessary.

In still other embodiments, the emergency steps may include the location identification of the charging station currently being used by the EV 200. For example, in some examples, the control module 102 may flag the current location of the EV 200 using its global positioning system (GPS). In such examples, the current location may be stored locally and/or transmitted (e.g., in real time) to another module (e.g., cloud-based storage, etc.), the emergency service provider, etc. Additionally, the control module 102 may flag the route taken by the EV 200 to get to safety, and then transmit that route (e.g., an end location) to the emergency service provider if subsequent response if needed.

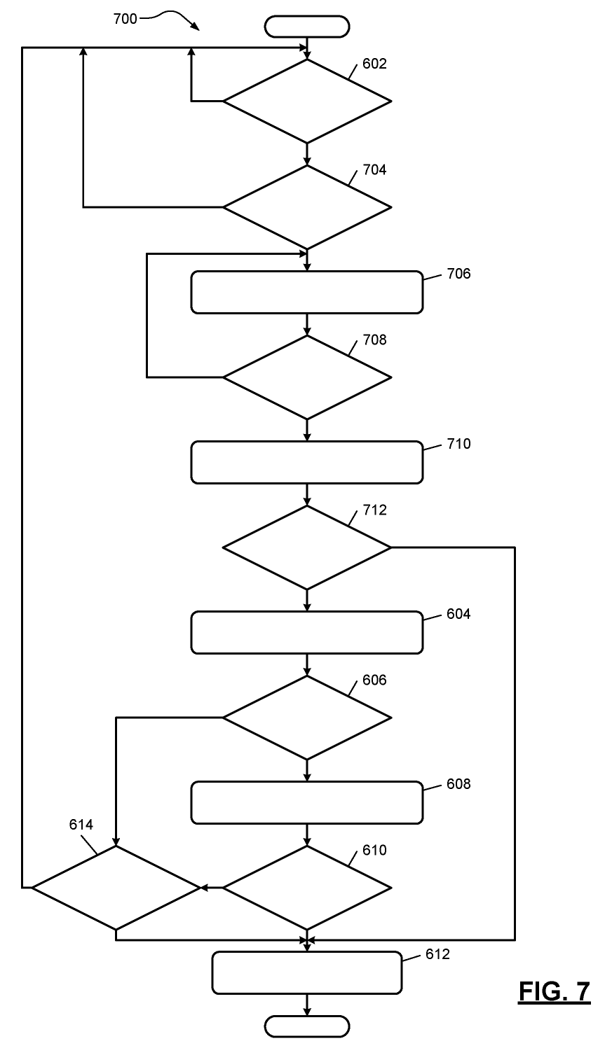

FIGS. 6-8 illustrate example control processes 600, 700, 800 employable by the vehicle system 100 for automatically releasing the charger plug 400 of FIG. 4 from the charging port 230 on the EV 200 of FIGS. 2-3. Although the example control processes 600, 700, 800 are described in relation to the vehicle system 100, the EV 200, the charging port 230, and the charger plug 400 of FIGS. 1-4, any one of the control processes 600, 700, 800 may be employable by another suitable vehicle system, EV, charging port, and/or charger plug.

As shown in FIG. 6, the control process 600 begins at 602 by determining whether an input signal is received to release the charger plug 400 from the charging port 230 while the charger plug 400 is providing power to the EV 200. For example, and as explained above, the input signal may be received by the control module 102 from a driver, a passenger, etc. selecting a user input (e.g., a button, a switch, a lever, etc.) located inside a cabin of the EV 200. If no input signal is received, control returns to 602. Otherwise, if an input signal is received, control proceeds to 604.

At 604, the control module 102 controls the release device 116 to release the latching member 410 of the charger plug 400 from the charging port 230. In such examples, the control module 102 may transmit a control signal to the release device 116 causing the release device 116 to actuate and move the latching member 410. The release device 116 may be any suitable controllable device, such as an electric and/or mechanical component that can provide a pulse with enough magnitude to unlatch the latching member 410. In various embodiments, the release device 116 may include, for example, a solenoid, a spring, an actuator, etc. Control then proceeds to 606.

At 606, the control module 102 determines whether the latching member 410 is unlocked or unlatched from the charging port 230. For instance, and as explained above, the control module 102 may make this determination based on a sensor input (e.g., from one of the sensors 118) indicating a position/state of the release device 116, a position or absence of the latch 418, etc. Alternatively, the control module 102 may make this determination based on a defined period of time (e.g., a calibratable time) after a control signal was sent to the release device 116. If the latching member 410 is determined to be not unlocked (e.g., still locked or latched), control proceeds to 614. If, however, the latching member 410 is determined to be unlocked, control proceeds to 608.

At 608, the control module 102 controls the actuator 114 of the charging port 230 to cause the ejectors 342, 344 to extend and eject the charger plug 400. For example, and as explained above, the control module 102 may transmit a control signal to the actuator 114 causing the actuator 114 to actuate and move the ejectors 342, 344. Control then proceeds to 610.

At 610, the control module 102 determines whether the charger plug 400 is ejected from the charging port 230. In some examples, the control module 102 may make this determination based on a sensor input (e.g., from one of the sensors 118) indicating whether a charger plug is present, etc. Alternatively, the control module 102 may make this determination based on a defined period of time (e.g., a calibratable time) after a control signal was sent to the actuator 114. If the charger plug 400 is determined to be not ejected (e.g., remains connected to the charging port 230), control proceeds to 614. If, however, the charger plug 400 is determined to be ejected, control proceeds to 612.

At 612, the control module 102 enables a propulsion system of the EV 200 to allow the driver to safely and quickly drive away without forcing the driver to exit the EV 200 to manually unplug the charger plug 400. In such examples, the control module 102 may transmit a control signal to the propulsion control module 106 to enable a powertrain of the EV 200 to go into propulsion. The control process 600 may then end as shown in FIG. 6.

At 614, the control module 102 determines whether an override input signal is received. For example, the override input signal may be received from a driver, a passenger, etc. selecting a user input located inside the cabin of the EV 200. This selectable input may be displayed, for example, after a failed attempt to eject the charger plug 400, after a failed attempt to disengage the latching member 410, etc. If no override input signal is received at 614, the control process 600 returns to 602 as shown in FIG. 6. If, however, an override input signal is received, the control process 600 proceeds to 612 where the propulsion system of the EV 200 is enabled.

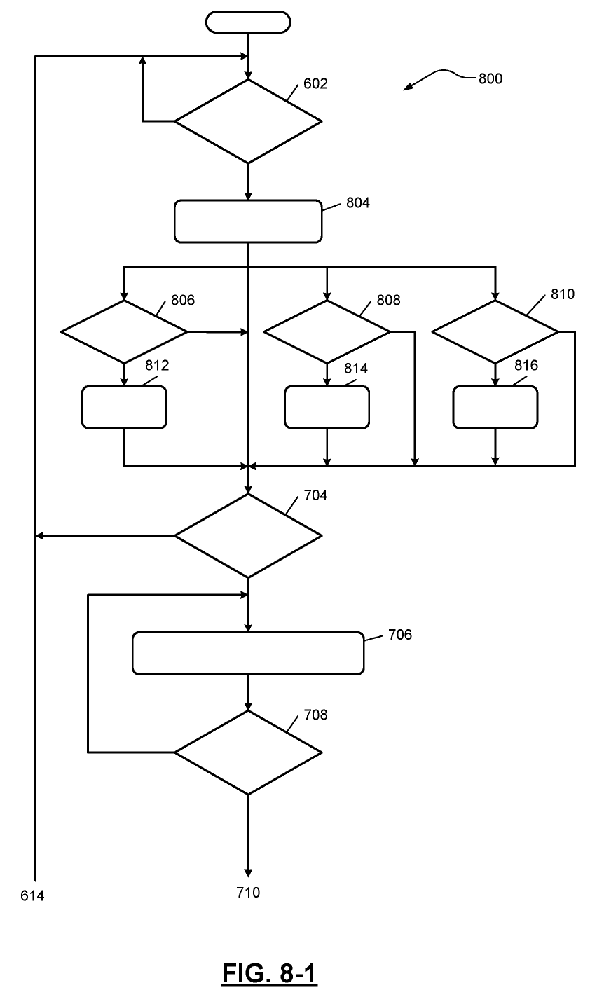

In FIG. 7, the control process 700 is similar to the control process 600 of FIG. 6 but includes additional steps. For example, and as shown in FIG. 7, the control process 700 begins at 602 of FIG. 6 where the control module 102 determines whether any input signal is received to release the charger plug 400 from the charging port 230. If no, control returns to 602. Otherwise, if an input signal is received, control proceeds to 704.

At 704, the control module 102 determines whether the release device 116 (e.g., a solenoid, etc.) is experiencing a fault condition. For example, the release device 116 may experience a hardware failure (e.g., a faulty power and/or control connection, etc.) or another type of failure preventing the release device 116 from functioning properly. If the control module 102 determines that the release device 116 is experiencing a fault condition (e.g., the release device 116 is not ready), control returns to 602. If, however, the control module 102 determines that the release device 116 is not experiencing a fault condition (e.g., the release device 116 is ready), control proceeds to 706.

At 706, the control module 102 commands a charging current provided to the charging port 230 to zero. For example, and as explained above, the control module 102 may transmit a control signal to a charger control module in the charger plug 400 (or a charging station with the charger plug 40) to command a charging current to zero. Control then proceeds to 708.

At 708, the control module 102 determines whether the charging current is below a threshold. For instance, the control module 102 may receive a signal from a current sensor (e.g., the current sensor 510 of FIG. 5) indicating the charging current, and then compare the sensed charging current to a threshold (e.g., zero, substantially zero, etc.). If the charging current is greater than or equal to the threshold, control returns to 706 where the control module 102 again commands the charging current to zero. If the charging current is less than the threshold, control proceeds to 710.

At 710, the control module 102 controls a switching device coupled between an input of the charging port 230 and a battery module in the EV 200 to open. For example, and as explained above, the control module 102 may transmit a control signal to selectively open the switching device, thereby causing the voltage provided to the battery module to fall to zero. Control then proceeds to 712.

At 712, the control module 102 determines whether at least one ejector is present for ejecting the charger plug 400 from the charging port 230. In various embodiments, this determination may be by stored vehicle data, a sensor input, etc. If the control module 102 determines that no ejector is present, control proceeds to 612 as explained above relative to FIG. 6. Otherwise, if the control module 102 determines that at least one ejector is present, control proceeds to 604 as explained above relative to FIG. 6. Then, control proceeds to 602, 606, 608, 610, 612, and/or 614 as explained above relative to FIG. 6.

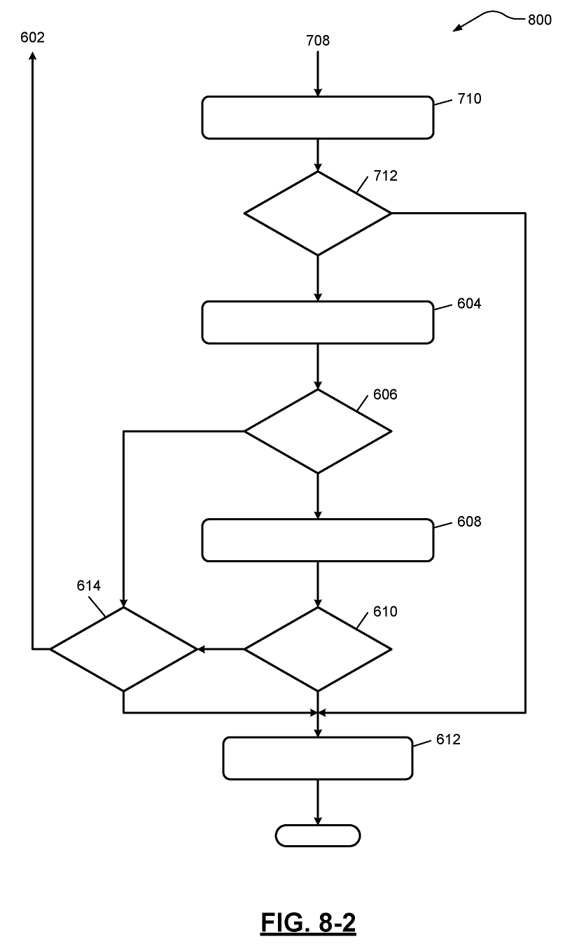

The control process 800 is shown across FIGS. 8-1 and 8-2, collectively referred to as FIG. 8 herein. In FIG. 8, the control process 800 is similar to the control processes 600, 700 of FIGS. 6-7 but includes additional steps. For example, and as shown in FIG. 8, the control process 800 begins at 602 of FIG. 6 where the control module 102 determines whether any input signal is received to release the charger plug 400 from the charging port 230. If no, control returns to 602. If, however, an input signal is received, control proceeds to 804.

At 804, the control module 102 initiates an emergency protocol. For example, and as explained above, the control module 102 may initiate communication with an emergency service provider, activate one or more output devices (e.g., a horn, lights, speakers, etc.) to generate an audible and/or visual alarm, activate one or more recording devices (e.g., one or more cameras, microphones, etc.) within or on the body of the EV 200 to capture video and/or audio near the EV 200, record and transmit location date (e.g., GPS coordinates, routes, etc.) of the charging location and/or a vehicle route taken to leave the charging location, etc. Control then proceeds to 806, 808, 810.

At 806, the control module 102 determines whether any vehicle window of the EV 200 is open. This determination may be made based on, for example, a sensor input. If no windows are open, control proceeds to 704 as explained above relative to FIG. 7. Otherwise, if a window is open, control proceeds to 812 where the control module 102 controls that vehicle window to close. Control then proceeds to 704. In various embodiments, the control process 800 may automatically command all vehicle windows to close regardless of the state of each window.

At 808, the control module 102 determines whether the vehicle doors of the EV 200 are locked. This determination may be made based on, for example, a sensor input. If yes at 808, control proceeds to 704. Otherwise, if a window is open, control proceeds to 814 where the control module 102 controls the vehicle doors to lock. Control then proceeds to 704. In other examples, the control process 800 may automatically command all vehicle doors to lock if desired.

At 810, the control module 102 determines whether any vehicle door or trunk of the EV 200 is open based on, for example, a sensor input. If no at 810, control proceeds to 704. Otherwise, if a vehicle door or trunk is open, control proceeds to 816 where the control module 102 controls the open door or trunk to close. Control then proceeds to 704. In other embodiments, the control process 800 may automatically command all vehicle doors and the trunk (if present) to close if desired.

At 704, the control module 102 determines whether the release device 116 (e.g., a solenoid, etc.) is experiencing a fault condition as explained above relative to FIG. 7. Then, control proceeds to 706, 708, 710, 712, 602, 604, 606, 608, 610, 612, and/or 614 as explained above relative to FIGS. 6-7.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “module” or the term “controller” may be replaced with the term “circuit.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

The term code, as used above, may include software, firmware, and/or microcode, and may refer to programs, routines, functions, classes, data structures, and/or objects. The term shared processor circuit encompasses a single processor circuit that executes some or all code from multiple modules. The term group processor circuit encompasses a processor circuit that, in combination with additional processor circuits, executes some or all code from one or more modules. References to multiple processor circuits encompass multiple processor circuits on discrete dies, multiple processor circuits on a single die, multiple cores of a single processor circuit, multiple threads of a single processor circuit, or a combination of the above. The term shared memory circuit encompasses a single memory circuit that stores some or all code from multiple modules. The term group memory circuit encompasses a memory circuit that, in combination with additional memories, stores some or all code from one or more modules.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks, flowchart components, and other elements described above serve as software specifications, which can be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation) (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Swift, Haskell, Go, SQL, R, Lisp, Java®, Fortran, Perl, Pascal, Curl, OCaml, JavaScript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

What is claimed is:

1. A vehicle system for automatically releasing a charger plug having a latching member from an electric vehicle, the vehicle system comprising:
a charging port configured to attach to the charger plug via the latching member, the charging port including at least one ejector, an actuator coupled to the at least one ejector, and a release device; and
a control module configured to:
receive an input signal to release the charger plug from the charging port while the charger plug is providing power to the electric vehicle;
in response to receiving the input signal, control the release device to release the latching member of the charger plug from the charging port;
control the actuator to cause the at least one ejector to extend from the charging port to eject the charger plug; and
in response to the charger plug being ejected, enable a propulsion system of the electric vehicle.

2. The vehicle system of claim 1, wherein the control module is configured to transmit a control signal to a charger control module in the charger plug to command a charging current to zero in response to receiving the input signal.

3. The vehicle system of claim 2, wherein:
the vehicle system includes a switching device coupled between an input of the charging port and a battery module in the electric vehicle for providing power to the battery module from the charger plug when the charger plug is attached to the charging port; and
the control module is configured to sense the charging current and control the switching device to open in response to charging current being below a threshold to remove a charging voltage.

4. The vehicle system of claim 2, wherein the control module is configured to:
in response to receiving the input signal, determine whether the latching member of the charger plug is released from the charging port; and
in response to the latching member not being released, enable the propulsion system of the electric vehicle.

5. The vehicle system of claim 1, wherein the control module is configured to:
determine whether a vehicle door is open; and
in response to determining that the vehicle door is open, automatically control the vehicle door to close.

6. The vehicle system of claim 1, wherein the control module is configured to:
determine whether a vehicle window is down; and
in response to determining that the vehicle window is down, automatically control the vehicle window to close.

7. The vehicle system of claim 1, wherein the control module is configured to:
determine whether a vehicle door is locked; and
in response to determining that the vehicle door is unlocked, automatically control the vehicle door to lock.

8. The vehicle system of claim 1, wherein the control module is configured to activate an output device in response to receiving the input signal.

9. The vehicle system of claim 8, wherein the output device includes at least one of an audible alarm or a visual alarm.

10. The vehicle system of claim 8, wherein the control module is configured to activate a recording device in response to receiving the input signal.

11. The vehicle system of claim 8, wherein the control module is configured to initiate communication with an emergency service provider in response to receiving the input signal.

12. The vehicle system of claim 1, wherein:
the release device includes a solenoid; and
the ejector includes one or more movable pins.

13. The vehicle system of claim 1, wherein the input signal is a user generated signal or a signal generated without user interaction.

14. A control method for automatically releasing a charger plug having a latching member from a charging port of an electric vehicle, the charging port including at least one ejector, an actuator coupled to the at least one ejector, and a release device, the control method comprising:
receiving an input signal to release the charger plug from the charging port of the electric vehicle while the charger plug is providing power to the electric vehicle;
in response to receiving the input signal, controlling the release device of the charging port to release the latching member of the charger plug from the charging port;
controlling the actuator of the charging port to cause the at least one ejector of the charging port to extend from the charging port to eject the charger plug; and
in response to the charger plug being ejected, enabling a propulsion system of the electric vehicle.

15. The control method of claim 14, further comprising transmitting a control signal to a charger control module in the charger plug to command a charging current to zero in response to receiving the input signal.

16. The control method of claim 15, further comprising:
sensing the charging current; and
in response to charging current being below a threshold, controlling a switching device coupled between an input of the charging port and a battery module in the electric vehicle to open.

17. The control method of claim 14, further comprising activating at least one of an audible alarm or a visual alarm in response to receiving the input signal.

18. The control method of claim 14, further comprising initiating communication with an emergency service provider in response to receiving the input signal.

19. The control method of claim 14, wherein:
the release device includes a solenoid; and
the ejector includes one or more movable pins.

20. A vehicle system for automatically releasing a charger plug from an electric vehicle, the vehicle system comprising:
a charging port configured to attach to the charger plug, the charging port including at least one ejector and an actuator coupled to the at least one ejector;
a switching device coupled between an input of the charging port and a battery module in the electric vehicle for providing power to the battery module from the charger plug when the charger plug is attached to the charging port; and
a control module configured to:
receive an input signal to release the charger plug from the charging port while the charger plug is providing power to the electric vehicle;
in response to receiving the input signal, transmit a control signal to a charger control module in the charger plug to command a charging current to zero;
control the switching device to open; and
in response to opening the switching device, control the actuator to cause the at least one ejector to extend from the charging port to eject the charger plug.
